(19) United States
(12) Patent Application Publication
(10) Pub. No.: US 2016/0208148 A1
(43) Pub. Date: Jul. 21, 2016

(54) DOUBLE-SIDED PRESSURES-SENSITIVE-ADHESIVE SHEET AND IMAGE DISPLAY DEVICE

(71) Applicant: MITSUBISHI PLASTICS, INC., Tokyo (JP)

(72) Inventors: Kahoru NIIMI, Nagahama-shi (JP); Shinya FUKUDA, Nagahama-shi (JP); Makoto INENAGA, Nagahama-shi (JP)

(73) Assignee: MITSUBISHI PLASTICS, INC., Chiyoda-ku, Tokyo (JP)

(21) Appl. No.: 14/912,766

(22) PCT Filed: Jul. 17, 2014
(86) PCT No.: PCT/JP14/69090

§ 371 Date: Feb. 18, 2016

(30) Foreign Application Priority Data
Aug. 21, 2013 (JP) 2013-171200

(51) Int. Cl. C09J 151/00; B32B 7/12; C09J 133/08; C09J 7/02

(52) U.S. Cl. CPC C09J 151/003; C09J 7/0217; B32B 7/12; C09J 133/08; C09J 2433/00; B32B 2255/26; B32B 2457/20; B32B 2457/208; C09J 2451/00

(57) ABSTRACT

Provided is a new double-sided pressure-sensitive-adhesive sheet which is not only able to realize a low dielectric constant but also exhibits excellent handleability or reliability as a pressure-sensitive-adhesive sheet. Proposed is a double-sided pressure-sensitive-adhesive sheet which includes an acrylic compound (A) having a specific dielectric constant at a frequency of 100 kHz of 3.0 or less and an acrylic acid ester copolymer (B) obtained by copolymerizing a (meth)acrylic acid ester monomer having a straight-chain or branched alkyl group having from 1 to 9 carbon atoms in a side chain and/or a vinyl ether monomer.

### TECHNICAL FIELD

The present invention relates to a double-sided pressure-sensitive-adhesive sheet having a low dielectric constant. Among them, it preferably relates to a double-sided pressure-sensitive-adhesive sheet which can be suitably used for bonding an image display device constituting member, for example, an image display device constituting member having a touch sensor, and an image display device using the same.

### BACKGROUND ART

In recent years, in order to improve the visibility of the image display device, it has been performed that the gap between an image display panel such as a liquid crystal display (LCD), a plasma display (PDP), or an electroluminescence display (ELD) and a protective panel or a touch panel member to be disposed on the front side (viewing side) thereof is filled with a pressure-sensitive-adhesive sheet or a liquid adhesive to suppress the reflection of incident light or light emitted from the display image at an air layer interface.

As the method to fill the gap between such image display device constituting members using an adhesive, a method is known in which a liquid adhesive resin composition containing an ultraviolet-curable resin is filled in the gap and then cured by irradiating with ultraviolet light (Patent Document 1).

However, in such a method, not only the work at the time of filling the liquid is complicated to decrease the productivity but also there is a problem that it is difficult to cure the adhesive in the place where ultraviolet light hardly reaches such as the part to be concealed by the printed hiding layer and thus it is difficult to obtain a stable quality.

Hence, a method to fill the gap between the image display device constituting members using a pressure-sensitive-adhesive sheet or a pressure-sensitive-adhesive sheet for achieving the purpose is disclosed.

For example, in Patent Document 2, a pressure-sensitive-adhesive sheet which includes one or more layers of a first pressure-sensitive adhesive layer and a second pressure-sensitive adhesive layer which have different viscoelastic behaviors, respectively, and has a configuration formed by laminating and integrating these layers and in which the value of dynamic shear storage modulus G′ measured at temperature variance of a frequency of 1 Hz is within a specific range is disclosed as a transparent pressure-sensitive-adhesive sheet that can be suitably used for bonding a transparent panel such as a protective panel or a touch panel to an image display panel.

A double-sided pressure-sensitive-adhesive sheet is disclosed in Patent Document 3, which includes an intermediate resin layer (A) and a pressure-sensitive adhesive layer (B) as front and back surface layers and in which each of the layers is a layer which contains one or more kinds of (meth)acrylic acid ester-based (co)polymers as a base resin, the storage shear modulus (G′(A)) of the intermediate resin layer (A) at a frequency of 1 Hz is higher than that of the pressure-sensitive adhesive layer (B) in a temperature range of 0 to 100° C., and the indentation hardness (Aster C2 hardness) of the entire sheet is from 10 to 80.

Incidentally, in recent years, an image display device that is equipped with a touch sensor function mainly including a mobile phone or a mobile terminal, in particular an image display device that is equipped with an electrostatic capacitance-type touch sensor function has become popular. Such an electrostatic capacitance-type touch sensor is a touch sensor having a type of detecting the position by detecting a change in the capacitance of the capacitor formed between two electrodes which are opposed via an insulating film as a conductor such as a finger approaches from the surface protective panel side.

However, the distance between the electrode and the surface of the protective panel has been narrowed in association with the thinning of the members in recent years, and thus a problem has been caused that noise is likely to be generated in the detection signal when the capacitance change in response to a touch is great. Hence, it is desired to lower the dielectric constant of the pressure-sensitive-adhesive sheet in order to suppress the generation of noise in the detection signal by allowing the pressure-sensitive-adhesive sheet used to be filled between the electrode and the surface protective panel to absorb a change in touch detection sensitivity.

In addition, a glass electrode substrate has been replaced with a resin film electrode substrate in association with the weight saving and cost reduction of the electrode. In the case of an electrode having a conductive thin film patterned only on one side, it is required to laminate two film electrodes or a glass electrode and the film electrode via a pressure-sensitive-adhesive sheet, and the pressure-sensitive-adhesive sheet used at that time is also desired to have a low dielectric constant.

With regard to a pressure-sensitive-adhesive sheet having a low dielectric constant, for example, in Patent Document 4, a sheet composed of a pressure-sensitive adhesive composition which uses an acrylic acid ester copolymer obtained by copolymerizing a methacrylic acid ester monomer having a specific carbon number range in the side chain and has a low dielectric constant is disclosed as a pressure-sensitive adhesive composition suitable for bonding a touch panel.

### CITATION LIST

### Patent Document

Patent Document 1: WO 2010/027041 A

Patent Document 2: WO 2010/044229 A

Patent Document 3: WO 2011/129200 A

Patent Document 4: JP 2013-001761 A

### SUMMARY OF THE INVENTION

### Problem to be Solved by the Invention

Even it is possible to achieve a decrease in dielectric constant of the pressure-sensitive-adhesive sheet, the original function of the pressure-sensitive-adhesive sheet is desired. In other words, the pressure-sensitive-adhesive sheet is desired not to be foamed or peeled off by an environmental change such as a temperature change or a humidity change and to exhibit adequate elasticity or recovery properties from indentation. However, as disclosed in Patent Document 4, there is a possibility that an acrylic acid ester copolymer containing a methacrylic acid ester having a long side chain length as a main component cannot obtain sufficient processability or bonding reliability due to a decrease in optical properties by crystallization when the side chain exhibits crystallinity, an insufficient cohesive force caused by an insufficient strength derived from the long alkyl side chain, or the like.

Hence, the invention is intended to provide a new double-sided pressure-sensitive-adhesive sheet which is not only able to realize a low dielectric constant but also exhibits excellent handleability or reliability as a pressure-sensitive-adhesive sheet.

### Means for Solving Problem

The invention provides a double-sided pressure-sensitive-adhesive sheet which includes an acrylic compound (A) having a specific dielectric constant at a frequency of 100 kHz of 3.0 or less and an acrylic acid ester copolymer (B) obtained by copolymerizing a (meth)acrylic acid ester monomer having a straight-chain or branched alkyl group having from 1 to 9 carbon atoms in a side chain and/or a vinyl ether monomer.

Such a double-sided pressure-sensitive-adhesive sheet may be, for example, a double-sided pressure-sensitive-adhesive sheet having a laminated constitution equipped with a layer (layer I) containing the acrylic compound (A) and a layer (layer II) containing the acrylic acid ester copolymer (B), a double-sided pressure-sensitive-adhesive sheet having a laminated constitution equipped with a layer (layer I) containing the acrylic compound (A) and the acrylic acid ester copolymer (B) and a layer (layer II) containing the acrylic acid ester copolymer (B), a double-sided pressure-sensitive-adhesive sheet of a single layer composed of a layer (layer II) containing the acrylic compound (A) and the acrylic acid ester copolymer (B), or a double-sided pressure-sensitive-adhesive sheet having another laminated constitution.

### Effect of the Invention

The double-sided pressure-sensitive-adhesive sheet proposed by the invention contains an acrylic compound (A) having a low dielectric constant, that is, having a specific dielectric constant at a frequency of 100 kHz of 3.0 or less, thus it is not only possible to lower the specific dielectric constant of the entire sheet but it is also possible to form the entire pressure-sensitive-adhesive sheet into a crosslinked structure, and thus it is also possible to enhance handleability (ease of handling), for example, the sheet shape can be maintained even though the sheet is heated.

Furthermore, the double-sided pressure-sensitive-adhesive sheet proposed by the invention contains an acrylic acid ester copolymer (B) obtained by copolymerizing a (meth)acrylic acid ester monomer having a straight-chain or branched alkyl group having from 1 to 9 carbon atoms in a side chain and/or a vinyl ether monomer, and thus it is possible to obtain suitable pressure-sensitive adhesive properties. For example, the bonded members are not foamed or peeled off by an environmental change such as a temperature change or a humidity change and moreover can exhibit adequate elasticity or recovery properties from indentation.

Consequently, the double-sided pressure-sensitive-adhesive sheet proposed by the invention can be one which is not only able to realize a low dielectric constant but also exhibits excellent handleability or adhesive reliability as a pressure-sensitive-adhesive sheet.

### MODE(S) FOR CARRYING OUT THE INVENTION

Next, the invention will be described on the basis of exemplary embodiments. However, the invention is not limited to the embodiments to be described below.

<Present Double-Sided Pressure-Sensitive-Adhesive Sheet>

The double-sided pressure-sensitive-adhesive sheet according to an example of embodiments of the invention (referred to as the “present double-sided pressure-sensitive-adhesive sheet”) is one which contains an acrylic compound (A) having a specific dielectric constant at a frequency of 100 kHz of 3.0 or less and an acrylic acid ester copolymer (B) obtained by copolymerizing a (meth)acrylic acid ester monomer having a straight-chain or branched alkyl group having from 1 to 9 carbon atoms in a side chain and/or a vinyl ether monomer.

The present double-sided pressure-sensitive-adhesive sheet can achieve a decrease in specific dielectric constant of the entire sheet as it contains an acrylic compound (A) having a low dielectric constant, that is, having a specific dielectric constant at a frequency of 100 kHz of 3.0 or less.

Among them, from the viewpoint of being able to further lower the specific dielectric constant of the present double-sided pressure-sensitive-adhesive sheet, the content of the acrylic compound (A) in the present double-sided pressure-sensitive-adhesive sheet is preferably 10 to 95% by mass and it is even more preferably 15% by mass or more or 90% by mass or less among them and 20% by mass or more or 85% by mass or less among them.

<Acrylic Compound (A)>

It is important that the specific dielectric constant of the acrylic compound (A) at a frequency of 100 kHz is 3.0 or less from the viewpoint of a suitably low specific dielectric constant, and the specific dielectric constant is preferably 2.9 or less and more preferably 2.8 or less.

As the acrylic compound (A), a polyfunctional (meth)acrylic acid ester having a polyolefin backbone and a weight average molecular weight of from 500 to 100,000 is preferably used.

It is not concerned that the specific dielectric constant of the acrylic compound (A) is too high or the cured product thereof is brittle as the weight average molecular weight of the acrylic compound (A) is 500 or more. On the other hand, it is not only possible to obtain a sufficient curing reaction efficiency but also to maintain the operability when preparing the composition since the viscosity is not too high as the weight average molecular weight of the acrylic compound (A) is 100,000 or less.

From this point of view, the molecular weight is even more preferably 600 or more or 80,000 or less and more preferably 700 or more or 60,000 or less among them.

In addition, it is possible to lower the specific dielectric constant of the acrylic compound (A) as the acrylic compound (A) has a polyolefin backbone as described above, and it is possible to have a composition to be preferable for crosslinking as the acrylic compound (A) is a polyfunctional (meth)acrylic acid ester.

From this point of view, examples of the acrylic compound (A) may include: a polyfunctional (meth)acrylic acid ester having two or more (meth)acryloyl groups and a homopolymer backbone of ethylene, propylene, butene, isobutylene, butadiene, isoprene, hydrogenated butadiene, hydrogenated isoprene, or hydrogenated styrene or a copolymer backbone of two or more components.

Among the acrylic compounds (A), a urethane (meth)acrylate obtained by reacting a polyolefin (a-1) having a hydroxyl group at the terminal or in the side chain, an aliphatic polyisocyanate (a-2), and a hydroxyl group-containing (meth)acrylate (a-3) is even more preferable.

A polyfunctional (meth)acrylic acid ester having a polyolefin backbone has a low dielectric constant, and thus it is possible to lower the dielectric constant of the entire sheet by blending such a polyfunctional (meth)acrylic acid ester. However, the results of the test conducted using many kinds of polyfunctional (meth)acrylic acid esters have demonstrated that the haze is increased after crosslinking since the polyfunctional (meth)acrylic acid ester is not favorably dispersed and mixed with the acrylic acid ester copolymer (B) when they are mixed together in most cases. It has been found that the urethane (meth)acrylate obtained by reacting the above three components (a-1) to (a-3) is favorably dispersed and mixed with the acrylic acid ester copolymer (B) among them, and thus the haze after crosslinking can be suppressed low. Consequently, the urethane (meth)acrylate is suitably used in an image display device requiring transparency.

In such a urethane (meth)acrylate, the polyolefin (a-1) having a hydroxyl group at the terminal or in the side chain can function as a component to lower the specific dielectric constant.

From this point of view, examples of the polyolefin (a-1) may include: a homopolymer of ethylene, propylene, butene, isobutylene, butadiene, isoprene, hydrogenated butadiene, hydrogenated isoprene, or hydrogenated styrene; or an alcohol having a copolymer of two or more components as the backbone structure. Among them, from the viewpoint of also obtaining transparency or toughness, terminal hydroxyl group-modified hydrogenated polybutadiene and terminal hydroxyl group-modified hydrogenated polyisoprene are preferable.

In the urethane (meth)acrylate, the aliphatic polyisocyanate (a-2) is a compound having two or more isocyanate groups in one molecule and preferably has an aliphatic backbone from the viewpoint of optical properties. Examples thereof may include an aliphatic diisocyanate-based compound such as hexamethylene diisocyanate, trimethylhexamethylene diisocyanate, dimer acid diisocyanate, lysine diisocyanate, isophorone diisocyanate, 4,4′-methylenebis(cyclohexyl isocyanate), methylcyclohexane-2,4-diisocyanate, methylcyclohexane-2,6-diisocyanate, 1,3-di(isocyanatomethyl)cyclohexane, 1,4-di(isocyanatomethyl)cyclohexane, 1,4-cyclohexane diisocyanate, 1,3-cyclopentane diisocyanate, or 1,2-cyclohexane diisocyanate, and any biuret type adduct and any isocyanurate ring adduct of these polyisocyanates.

Among them, a diisocyanate-based compound having an alicyclic structure such as isophorone diisocyanate, 4,4′-methylenebis(cyclohexyl isocyanate), methylcyclohexane-2,4-diisocyanate, methylcyclohexane-2,6-diisocyanate, 1,3-di(isocyanatomethyl)cyclohexane, 1,4-di(isocyanatomethyl)cyclohexane, 1,4-cyclohexane diisocyanate, 1,3-cyclopentane diisocyanate, or 1,2-cyclohexane diisocyanate is preferable from the viewpoint of optical properties and mechanical strength.

In the urethane (meth)acrylate, the hydroxyl group-containing (meth)acrylate (a-3) can function as a crosslinkable component. In other words, it is possible to form a crosslinked structure by crosslinking the urethane (meth)acrylate by irradiating with ultraviolet light.

It is possible to provide a pressure-sensitive-adhesive sheet exhibiting excellent handleability or reliability by imparting crosslinkability to the acrylic compound (A) since the acrylic compound (A) does not only contributes to an increase in elasticity after curing but it is also not concerned that the acrylic compound (A) does not dissolve out as a low molecular weight component during a long-term storage or an environmental test.

Examples of the hydroxyl group-containing (meth)acrylate (a-3) may include various kinds of (meth)acrylate compounds having a hydroxyl group such as 2-hydroxyethyl (meth)acrylate, 2-hydroxypropyl (meth)acrylate, 2-hydroxybutyl (meth)acrylate, 3-hydroxybutyl (meth)acrylate, 4-hydroxybutyl (meth)acrylate, cyclohexanedimethanol mono(meth)acrylate, polyethylene glycol mono(meth)acrylate, polypropylene glycol mono(meth)acrylate, trimethylolpropane di(meth)acrylate, trimethylolethane di(meth)acrylate, pentaerythritol tri(meth)acrylate or glycidyl (meth)acrylate-(meth)acrylic acid adduct, and 2-hydroxy-3-phenoxypropyl (meth)acrylate.

The weight average molecular weight of the urethane (meth)acrylate is preferably from 500 to 100,000 and even more preferably 800 or more or 80,000 or less among them and 1,000 or more or 60000 or less among them from the viewpoint of achieving both an effect to lower the specific dielectric constant and high reactivity.

In addition, the refractive index of the urethane (meth)acrylate at D line is preferably from 1.40 to 1.60 and even more preferably 1.44 or more or 1.55 or less among them and 1.46 or more or 1.50 or less among them from the viewpoint of maintaining transparency when the urethane (meth)acrylate forms a composition with the acrylic acid ester copolymer (B).

The method for synthesizing the urethane (meth)acrylate is not particularly limited, and a known synthetic method may be appropriately used. For example the urethane (meth)acrylate can be obtained by reacting the (a-3) with the urethane prepolymer obtained by reacting the (a-1) and the (a-2). However, the method is not intended to be limited to this method.

<Acrylic Acid Ester Copolymer (B)>

The acrylic acid ester copolymer (B) is a component that imparts suitable pressure-sensitive adhesive properties to the present double-sided pressure-sensitive-adhesive sheet, and for example, the bonded members are not foamed or peeled off by an environmental change such as a temperature change or a humidity change and moreover can exhibit adequate elasticity or recovery properties from indentation.

The (meth)acrylic acid ester monomer that serves as the mainly component of the acrylic acid ester copolymer (B) is preferably a (meth)acrylic acid ester monomer having a straight-chain or branched alkyl group in the side chain from the viewpoint of imparting adequate stickiness (tackiness) as a pressure-sensitive-adhesive sheet.

In addition, the compatibility of the acrylic acid ester copolymer with the (meth)acrylic acid ester monomer or oligomer added as a crosslinking agent, other additives, or the like is poor when a (meth)acrylic acid ester copolymer containing a (meth)acrylate component having an alkyl group having 10 or more carbon atoms in the side chain is used as the acrylic acid ester copolymer, and thus it is concerned that not only the pressure-sensitive adhesive composition is turbid and the optical properties of the pressure-sensitive-adhesive sheet decrease but also the adhesive force or the holding force required as a pressure-sensitive-adhesive sheet is impaired by an insufficient mechanical strength derived from the long chain alkyl group. Among them, there is a possibility that the compatibility of the acrylic acid ester copolymer (B) with the acrylic compound (A) becomes poorer and the haze increases when the carbon number of the alkyl group increases.

From this point of view, the carbon number of the alkyl group of the side chain is preferably from 1 to 9 and preferably 2 or more or 8 or less among them and 3 or more or 8 or less among them.

As the (meth)acrylic acid ester monomer having a straight-chain or branched alkyl group having from 1 to 9 carbon atoms in the side chain, for example, those which contain one kind of an alkyl acrylate or alkyl methacrylate having any one of n-nonyl, isononyl, n-octyl, isooctyl, 2-ethylhexyl, n-butyl, isobutyl, tert-butyl, methyl, ethyl, propyl, or isopropyl as the alkyl group or two or more kinds selected from these as the copolymerizable component are preferable.

Among them, preferred examples may include those which are obtained by copolymerizing a combination of one kind or two or more kinds among alkyl acrylates such as isooctyl acrylate, n-octyl acrylate, n-butyl acrylate, and 2-ethylhexyl acrylate or a combination of one kind or two or more kinds among iso-octyl acrylate, n-octyl acrylate, n-butyl acrylate, and 2-ethylhexyl acrylate with vinyl acetate.

Among them, a (meth)acrylic acid ester copolymer containing 2-ethylhexyl acrylate and vinyl acetate as the copolymerizable component is even more preferable.

Incidentally, the acrylic acid ester copolymer (B) may contain isobornyl (meth)acrylate or an acrylate or methacrylate having an aliphatic cyclic structure such as 4-tert-butylcyclohexanol acrylate or 3,5,5-trimethylcyclohexanol acrylate in addition to an acrylate or methacrylate having an organic functional group such as hydroxyethyl (meth)acrylate, hydroxypropyl (meth)acrylate, hydroxybutyl (meth)acrylate, (meth)acrylic acid, glycidyl (meth)acrylate, (meth)acrylamide, (meth)acrylonitrile, a fluorine (meth)acrylate, or a silicone (meth)acrylate as a copolymerizable component as the component other than the above ones.

In addition, it is also possible to appropriately use vinyl acetate or various kinds of vinyl monomers such as styrene, alkyl vinyl ether, and hydroxyethyl vinyl ether which are copolymerizable with the acrylic monomer or methacrylic monomer in the polymerization.

The weight average molecular weight of the acrylic acid ester copolymer (B) is preferably from 100,000 to 700,000 and even more preferably from 120,000 to 600,000 among them and from 150,000 to 500,000 among them from the viewpoint of processing suitability and of imparting reliability after bonding the pressure-sensitive-adhesive sheet to an adherend.

In addition, the specific dielectric constant of the acrylic acid ester copolymer (B) is not particularly limited. However, in order not to increase the dielectric constant of the entire sheet, the specific dielectric constant thereof at a frequency of 100 kHz is preferably from 3.0 to 6.0 and even more preferably 3.3 or more or 5.5 or less among them and 3.5 or more or 5.0 or less among them.

As the polymerization method of the acrylic acid ester copolymer (B), it is possible to use the monomers described above and to adopt a known polymerization method such as solution polymerization, emulsion polymerization, bulk polymerization, or suspension polymerization, and it is possible to obtain the acrylic acid ester copolymer by using a polymerization initiator such as a thermal polymerization initiator or a photopolymerization initiator depending on the polymerization method at that time.

(Photopolymerization Initiator (C))

It is preferable to blend the photopolymerization initiator (C) in order to photocrosslink the present double-sided pressure-sensitive-adhesive sheet.

Either kind of a cleavage type photoinitiator or a hydrogen abstraction type photoinitiator may be used or both of them may be used in combination as the photopolymerization initiator (C).

Examples of the cleavage type photoinitiator may include benzoin butyl ether, benzyl dimethyl ketal, and 2-hydroxyacetophenone.

Examples of the hydrogen abstraction type photoinitiator may include benzophenon Michler's ketone, 2-ethylanthraguinone, and thioxanthone, or any derivative thereof.

However, the photoinitiator is not limited to the substances mentioned above.

((Meth)Acrylic Acid Ester Monomer (D))

It possible to crosslink the present double-sided pressure-sensitive-adhesive sheet by adding the (meth)acrylic acid ester monomer as a crosslinking agent.

The (meth)acrylic acid ester monomer can enhance the sense of the curing reaction or can enhance the compatibility between the acrylic compound (A) and the (meth acrylic acid ester copolymer (B). It is possible to impart a dilution effect particularly by adding a polyfunctional (meth)acrylic acid ester monomer, meanwhile, it is possible to impart a compatibilizing effect together the dilution effect by adding a monofunctional (meth)acrylic acid ester monomer. Hence, the (meth)acrylic acid ester monomer (D) may be added if necessary from this point of view.

Examples of the polyfunctional (meth)acrylic acid ester monomer may include an ultraviolet-curable polyfunctional monomer such as 1,4-butanediol di(meth)acrylate, 1,6-hexanediol di(meth)acrylate, 1,9-nonanediol di(meth)acrylate, tricyclodecanedimethanol (meth)acrylate, bisphenol A polyethoxy di(meth)acrylate, bisphenol A polypropoxy di(meth)acrylate, bisphenol F polyethoxy di(meth)acrylate, ethylene glycol di(meth)acrylate, trimethylolpropane trioxyethyl (meth)acrylate, tris(2-hydroxyethyl)isocyanurate tri(meth)acrylate, tris(2-hydroxyethyl)isocyanurate tri(meth)acrylate, ε-caprolactone-modified tris(2-hydroxyethyl)isocyanurate tri(meth)acrylate, pentaerythritol tri(meth)acrylate, propoxylated pentaerythritol tri(meth)acrylate, ethoxylated pentaerythritol tri(meth)acrylate, pentaerythritol tetra(meth)acrylate, propoxylated pentaerythritol tetra(meth)acrylate, ethoxylated pentaerythritol tetra(meth)acrylate, dipentaerythritol hexa(meth)acrylate, polyethylene glycol di(meth)acrylate, tris(acryloxyethyl)isocyanurate, pentaerythritol tetra(methacrylate, dipentaerythritol hexa(meth)acrylate, dipentaerythritol penta(meth)acrylate, tripentaerythritol hexa(meth)acrylate, tripentaerythritol penta(meth)acrylate, hydroxy pivalic acid neopentyl glycol di(meth)acrylate, di(meth)acrylate of ε-caprolactone adduct of hydroxy pivalic acid neopentyl glycol, trimethylolpropane tri(meth)acrylate, trimethylolpropanepolyethoxy tri(meth)acrylate, or ditrimethylolpropane tetra(meth)acrylate. Among them, a polyfunctional (meth)acrylate having three or more (meth)acryloyl groups is preferable from the viewpoint of reactivity or the strength of the cured product to be obtained.

In addition, the present pressure-sensitive-adhesive sheet may further contain one kind or two or more kinds of monofunctional (meth)acrylate-based monomers or vinyl monomers as the component that is co-curable with the component (A) or the polyfunctional (meth)acrylate if necessary from the viewpoint of enhancing the compatibility between the essential components (A) and (B) and adjusting the viscosity of the composition.

Examples of the monofunctional monomer may include 2-ethylhexyl (meth)acrylate, n-octyl acrylate, isooctyl (meth)acrylate, decyl (meth)acrylate, isodecyl (meth)acrylate, lauryl (meth)acrylate, myristyl (meth)acrylate, cetyl (meth)acrylate, stearyl (meth)acrylate, vinyl (meth)acrylate, n-butyl (meth)acrylate, secbutyl (meth)acrylate, isobutyl (meth)acrylate, propyl (meth)acrylate, ethyl (meth)acrylate, cyclohexyl (meth)acrylate, 4-tert-butylcyclohexyl (meth)acrylate, neopentyl (meth)acrylate, (meth)acrylic acid, 2-(meth)acryloyloxyethyl succinate, 2-(meth)acryloyloxypropyl hexahydrophthalate, hydroxyethyl (meth)acrylate, glycidyl (meth)acrylate, 2-hydroxy-3-phenoxypropyl (meth)acrylate, acrylonitrile, phenyl (meth)acrylate, toluyl (meth)acrylate, 2-naphthyl (meth)acrylate, 2-methoxycarbonylphenyl (meth)acrylate, dicyclopentadienyl (meth)acrylate, 4-ethoxylated-cumylphenol (meth)acrylate, 3,3,5-trimethylcyclohexanol (meth)acrylate, cyclic trimethylolpropane formal (meth)acrylate, tert-butyl (meth)acrylate, polyethylene glycol (meth)acrylate, polypropylene glycol (meth)acrylate, diethylene glycol monobutyl ether (meth)acrylate, 2-(2-ethoxyethoxy)ethyl (meth)acrylate, ethoxylated nonylphenol (meth)acrylate, methoxypolyethylene glycol mono(meth)acrylate, ethoxylated phenol (meth)acrylate, hydroxybutyl (meth)acrylate, 2-hydroxybutyl (meth)acrylate, 6-hydroxyhexyl (meth)acrylate, 2-hydroxypropyl (meth)acrylate, caprolactone-modified (meth)acrylate, hydroxypropyl (meth)acrylate, isopropyl (meth)acrylate, 2 phenoxyethyl (meth)acrylate, diethylene glycol methyl ether (meth)acrylate, isobornyl (meth)acrylate, tetrahydrofurfuryl (meth)acrylate, ethoxylated nonylphenol (meth)acrylate, benzyl (meth)acrylate, phenethyl (meth)acrylate, acrylamide, hydroxyethyl acrylamide, N,N-dimethylacrylamide, N,N-dimethylaminoethyl acrylamide, methylol acrylamide, styrene, and vinyl acetate.

With regard to the content of the (meth)acrylic acid ester monomer (D), when the amount of crosslinking agent is great, it is not only difficult to control the reaction since the reaction rapidly proceeds but it is also concerned that tackiness or flexibility that is desired as a pressure-sensitive-adhesive sheet is impaired after curing.

From this point of view, the content of the (meth)acrylic acid ester monomer (D) is preferably from 0 to 30% by mass, more preferably 25% by mass or less, and even more preferably 20% by mass or less based on 100% by mass of the composition which constitutes the pressure-sensitive-adhesive sheet.

(Other Components)

The present double-sided pressure-sensitive-adhesive sheet may also contain components other than the above ones. For example, the present double-sided pressure-sensitive-adhesive sheet may contain a polydimethyl siloxane resin or a thermal curing agent such as an organic peroxide, an isocyanate compound, an epoxy compound, or an amine compound if necessary as the curing agent or the crosslinkable material.

In addition, the present double-sided pressure-sensitive-adhesive sheet may contain known components which are blended into an ordinary pressure-sensitive adhesive composition. For example, it is possible to appropriately contain a pressure-sensitive adhesion-imparting resin or various kinds of additives such as an antioxidant, an anti-aging agent, and a moisture absorbing agent if necessary.

<Laminated Constitution>

The present double-sided pressure-sensitive-adhesive sheet may be a pressure-sensitive-adhesive sheet of a single layer composed of a pressure-sensitive adhesive layer or a pressure-sensitive-adhesive sheet having a multi-layer configuration equipped with an intermediate resin layer (layer I) and an adhesive layer (layer II).

For example, the present double-sided pressure-sensitive-adhesive sheet may be a double-sided pressure-sensitive-adhesive sheet of a single layer composed of a layer (layer II) containing the acrylic compound (A) and the acrylic acid ester copolymer (B), a double-sided pressure-sensitive-adhesive sheet having a laminated constitution equipped with a layer (layer I) containing the acrylic compound (A) and a layer (layer II) containing the acrylic acid ester copolymer (B), a double-sided pressure-sensitive-adhesive sheet having a laminated constitution equipped with a layer (layer I) containing the acrylic compound (A) and the acrylic acid ester copolymer (B) and a layer (layer II) containing the acrylic acid ester copolymer (B), or a double-sided pressure-sensitive-adhesive sheet having another laminated constitution.

In a case in which the present double-sided pressure-sensitive-adhesive sheet is a single-layer sheet composed of a layer (layer II) containing the acrylic compound (A) and the acrylic acid ester copolymer (B), the acrylic compound (A) has crosslinkability and high elasticity is obtained after curing, and thus it is possible to impart not only the electrical properties but also excellent handleability to the pressure-sensitive-adhesive sheet.

From this point of view, in the case of such a single-layer sheet, it is preferable to contain the acrylic compound (A) at from 10 to 99% by mass, and it is more preferable to contain the acrylic compound (A) at 20% by mass or more or 99% by mass or less among them and 30% by mass or more or 99% by mass or less among them, and it is even more preferable to contain the acrylic compound (A) at 50% by mass or more.

On the other hand, the acrylic acid ester copolymer (B) can impart tackiness and adhesive force to make the present double-sided pressure-sensitive-adhesive sheet a pressure-sensitive adhesive material.

From this point of view, in the case of such a single-layer sheet, the content of the acrylic acid ester copolymer (B) is preferably from 10 to 80% by mass and even more preferably 15% by mass or more or 80% by mass or less among them, and 20% by mass or more or 70% by mass or less among them.

On the other hand, in a case in which the present double-sided pressure-sensitive-adhesive sheet has such a laminated constitution as described above, it is possible to adopt a two-layer configuration of layer/layer II, a three-layer configuration of layer II/layer I/layer II, and further a multi-layer configuration including another layer as the laminated constitution equipped with layer I and layer II as described above. In addition, one side or both sides of the pressure-sensitive-adhesive sheet may be equipped with a release sheet regardless of the configuration of the pressure-sensitive-adhesive sheet.

The acrylic compound (A) has crosslinkability and high elasticity is obtained after curing, and thus it is possible to impart not only the electrical properties but also excellent handleability to the pressure-sensitive-adhesive sheet by using a layer containing the acrylic compound (A) as the intermediate layer, namely, the core material in the various kinds of laminated constitutions described above.

From this point of view, in the “layer I” of the various kinds of laminated constitutions described above, it is preferable to contain the acrylic compound (A) at from 10 to 99% by mass, and it is even more preferable to contain the acrylic compound (A) at 20% by mass or more or 99% by mass or less among them and 30% by mass or more or 99% by mass or less among them.

On the other hand, the acrylic acid ester copolymer can impart tackiness to make the sheet surface a pressure-sensitive-adhesive sheet, and thus it is possible to obtain high adhesive properties with respect to an adherend.

From this point of view, in the “layer II” of the various kinds of laminated constitutions described above, it is preferable to contain the acrylic acid ester copolymer (B) at from 10 to 99% by mass, and it is even more preferable to contain the acrylic acid ester copolymer (B) at 30% by mass or more or 99% by mass or less among them, and 50% by mass or more or 99% by mass or less among them.

<Thickness>

The lower limit of the thickness of the present double-sided pressure-sensitive-adhesive sheet is preferably 10 μm or more, more preferably 30 μm or more, and even more preferably 50 μm or more. On the other hand, the upper limit is preferably 1 mm or less, more preferably 500 μm or less, and even more preferably 250 μm or less.

Among them, when the thickness of the present adhesive sheet is 30 μm or more, even if there are irregular portions on the surface of members to be bonded, it is possible to bond the members to be bonded without leaving air bubbles around the step. When the thickness is 1 mm or less, it is possible to meet the requirement of being thinned.

In a case in which the present double-sided pressure-sensitive-adhesive sheet has the various kinds of laminated constitutions equipped with layer I and layer II, the ratio (I/II) of the thickness of layer I to the thickness of layer II is preferably from 0.25 to 10, and more preferably 0.5 or more or 5 or less among them, and even more preferably 1 or more or 3 or less among them.

Dielectric Constant>

In a case in which image display device constituting members with a touch panel function are bonded using a double-sided pressure-sensitive-adhesive sheet, particularly in a case in which touch panel function layers or a touch panel function layer and a surface protective member are bonded, the pressure-sensitive-adhesive sheet is required to have a function as an insulating layer. The pressure-sensitive-adhesive sheet is required to have a low specific dielectric constant from the viewpoint of decreasing the loss of high frequency electrical signals such as a touch signal. From this point of view, the specific dielectric constant of the present double-sided pressure-sensitive-adhesive sheet at a frequency of 100 kHz is preferably 3.5 or less and more preferably 3.2 or less.

Incidentally, in the case of a laminated constitution, it is possible to adjust the specific dielectric constant of the present double-sided pressure-sensitive-adhesive sheet by appropriately adjusting the thickness ratio of layer I to layer II.

<Adhesive Force>

The present double-sided pressure-sensitive-adhesive sheet preferably has a 180° peel force of 5.0 N/cm or more when one surface of the double-sided pressure-sensitive-adhesive sheet is superimposed and press-bonded on a soda-lime glass and the double-sided pressure-sensitive-adhesive sheet is peeled off from the soda-lime glass at 23° C. and a peeling speed of 60 mm/min. The present double-sided pressure-sensitive-adhesive sheet of the invention can maintain a sufficient adhesive force with respect to an adherend as a pressure-sensitive-adhesive sheet when the 180° peel force is in the regulated range.

<Transparency>

The present double-sided pressure-sensitive-adhesive sheet is preferably transparent in consideration of being used in an image display device. Specifically, the total light transmittance measured for the double-sided pressure-sensitive-adhesive sheet having both surfaces sandwiched between soda-lime glasses with a thickness of 0.5 mm in accordance with JIS K7361-1 is preferably 85% or more and more preferably 90% or more.

In addition, the haze of the present double-sided pressure-sensitive-adhesive sheet measured in accordance with JIS K7136 is preferably 5% or less and more preferably 2% or less for the same reason as the total light transmittance.

<Image Display Device Constituting Member>

In an image display device equipped with two facing image display device constituting members, it is possible to form the image display device by filling the present double-sided pressure-sensitive-adhesive sheet in between the two image display device constituting members.

Examples of the image display device constituting member may include any one kind selected from the group consisting of a touch panel, an image display panel, a surface protective panel, a retardation film, and a polarizing film, or a laminated body composed of a combination of two or more kinds thereof.

When bonding the image display device constituting members using the present double-sided pressure-sensitive-adhesive sheet, a pressure-sensitive-adhesive sheet obtained by curing (crosslinking) a pressure-sensitive adhesive composition may be used as it is or a pressure-sensitive-adhesive sheet in an uncrosslinked state or a B-stage state formed while leaving room for curing may be used.

In a case in which a pressure-sensitive-adhesive sheet is in the B-stage state, it is not only possible to more firmly stick the members to each other as the pressure-sensitive-adhesive sheet is cured by irradiating with light via the bonding members after two image display device constituting members are bonded using the pressure-sensitive-adhesive sheet, but it is also possible to relax the strain generated in the sheet at the time of bonding as the pressure-sensitive-adhesive sheet or some layers constituting the pressure-sensitive-adhesive sheet are in a state of being uncrosslinked or exhibiting high fluidity while leaving room for crosslinkage at the time point of bonding.

For example, it is possible to form a laminated body for constituting an image display device by forming a laminated body for constituting an image display device by laminating image display device constituting members via the present double-sided pressure-sensitive-adhesive sheet and irradiating the double-sided pressure-sensitive-adhesive sheet of this laminated body for constituting an image display device with ultraviolet light via the image display device constituting members so as to UV-crosslink the present double-sided pressure-sensitive-adhesive sheet. It is possible to constitute an image display device using such a laminated body for constituting an image display device.

At this time, examples of the image display device constituting member may include any one selected from the group consisting of a touch panel, an image display panel, a surface protective panel, a retardation film, and a polarizing film, or a laminated body composed of a combination of two or more kinds thereof.

<Description of Phrase>

In the present specification, in a case in which it is expressed “X to Y” (X and Y are arbitrary numbers), it also includes the meaning of “preferably greater than X” or “preferably less than Y” together with the meaning of “X or more and Y or less” unless otherwise stated.

In addition, in a case in which it is expressed “X or more” (X is an arbitrary number) or “Y or less” (Y is an arbitrary number), it also includes the intent to mean “preferable to be greater than X” or “preferable to be less than Y”.

### EXAMPLES

Hereinafter, the invention will be described in more detail on the basis of the following Examples and Comparative Examples.

(Composition 1 for Forming Layer I)

The composition 1 for forming layer I was prepared by uniformly mixing 0.5 kg of a urethane acrylate (A-1) having a hydrogenated polybutadiene backbone (CN9014NS manufactured by SARTOMER) as the acrylic compound (A), 0.5 kg of an acrylic acid ester copolymer (B-1) composed of 77 parts by mass of 2-ethylhexyl acrylate, 19 parts by mass of vinyl acetate, and 4 parts by mass of acrylic acid as the acrylic acid ester copolymer (B), and 10 g of a photopolymerization initiator (C-1) (ESACURE TZT manufactured by Lanberti S.p.A.) consisting of a mixture of 2,4,6-trimethylbenzophenone and 4-methylbenzophenone as the photopolymerization initiator (C).

Incidentally, the urethane acrylate (A-1) having a hydrogenated polybutadiene backbone was a urethane (meth)acrylate obtained by reacting a hydrogenated polybutadiene (a-1) having a hydroxyl group at the terminal, an aliphatic polyisocyanate (a-2), and a hydroxyl group-containing (meth)acrylate (a-3), and the weight average molecular weight thereof was 12,000, the specific dielectric constant thereof at a frequency of 100 kHz was 2.5, and the refractive index thereof at D line was 1.48.

Meanwhile, the weight average molecular weight of the acrylic acid ester copolymer (B-1) was 400,000 and the specific dielectric constant thereof at a frequency of 100 kHz was 3.8.

(Composition 2 for Forming Layer I)

A polybutadiene backbone-containing urethane acrylate (A-2) (CN310 manufactured by SARTOMER) was used as the acrylic compound (A), and the composition 2 for forming layer I was prepared by uniformly mixing 20 g of 1-hydroxycyclohexyl phenyl ketone (C-2) (Irgacure 184 manufactured by BASF) as the photopolymerization initiator (C) with 1 kg of this acrylic compound (A-2).

The polybutadiene backbone-containing urethane acrylate (A-2) was a urethane (meth)acrylate obtained by reacting a polybutadiene (a-1) having a hydroxyl group at the terminal, an aliphatic polyisocyanate (a-2), and a hydroxyl group-containing (meth)acrylate (a-3), the weight average molecular weight thereof was 13,000, the specific dielectric constant thereof at a frequency of 100 kHz was 2.6, and the refractive index thereof at D line was 1.51.

(Composition 3 for Forming Layer I)

An acrylic acid ester copolymer (B-1) obtained by random copolymerization of 77 parts by mass of 2-ethylhexyl acrylate, 19 parts by mass of vinyl acetate, and 4 parts by mass of acrylic acid was used as the acrylic acid ester copolymer (B), and the composition 3 for forming layer I was prepared by uniformly mixing 200 g trimethylolpropane triacrylate (D-1) as the (meth)acrylic acid ester monomer (D) and 15 g of 4-methyl benzophenone (C-3) (SpeedcureMBP manufactured by Lambson Limited) as the photopolymerization initiator (C) with 1 kg of this acrylic acid ester copolymer (B-1).

The weight average molecular weight of the ac acid ester copolymer (B-1) was 400,000 and the specific dielectric constant thereof at a frequency of 100 kHz was 3.8.

(Composition 1 for Forming Layer II)

The composition 1 for forming layer II was prepared by uniformly mixing 15 g of a photopolymerization initiator (C-1) (ESACURE TZT manufactured by Lanberti S.p.A.) consisting of a mixture of 2,4,6-trimethylbenzophenone and 4-methylbenzophenone as the photopolymerization initiator (C) with 1 kg of an acrylic acid ester copolymer (B-1) obtained by random copolymerization of 77 parts by mass of 2-ethylhexyl acrylate, 19 parts by mass of vinyl acetate, and 4 parts by mass of acrylic acid as the acrylic acid ester copolymer (B).

(Composition 2 for Forming Layer II)

The composition 2 for forming layer II was prepared in the same manner as the composition 1 for forming layer II except that an acrylic acid ester copolymer (B-2) obtained by random copolymerization of 83 parts by mass of butyl acrylate, 15 parts by mass of vinyl acetate, and 2 parts by mass of acrylic acid was used as the acrylic acid ester copolymer (B) instead of the acrylic acid ester copolymer (B-1).

The weight average molecular weight of the acrylic acid ester copolymer (B-2) was 350,000 and the specific dielectric constant thereof at a frequency of 100 kHz was 4.6.

(Composition 3 for Forming Layer II)

The composition 3 for forming layer II was prepared by uniformly mixing 200 g of a urethane acrylate (A-1) having a hydrogenated polybutadiene backbone (CN9014NS manufactured by SARTOMER, specific dielectric constant at frequency of 100 kHz: 2.5) as the acrylic compound (A) and 20 g of a photopolymerization initiator (C-1) (ESACURE TZT manufactured by Lanberti S.p.A.) consisting of a mixture of 2,4,6-trimethylbenzophenone and 4-methylbenzophenone as the photopolymerization initiator (C) with 1 kg of an acrylic acid ester copolymer (3-3) composed of 55 parts by mass of 2-ethylhexyl acrylate, 40 parts by mass of vinyl acetate, and 5 parts by mass of acrylic acid as the acrylic acid ester copolymer (3).

The weight average molecular weight of the acrylic acid ester copolymer (3-3) was 140,000 and the specific dielectric constant thereof at a frequency of 100 kHz was 3.7.

(Composition 4 for Forming Layer II)

The composition 4 for forming layer II was prepared by uniformly mixing 600 g of a polybutadiene diacrylate (A-3) (CN307 manufactured by SARTOMER, specific dielectric constant at frequency of 100 kHz: 2.6) as the acrylic compound (A) and 15 g of a photopolymerization initiator (C-1) (ESACURE TZT manufactured by Lanberti S.p.A.) consisting of a mixture of 2,4,6-trimethylbenzophenone and 4-methylbenzophenone as the photopolymerization initiator (C) with 1 kg of an acrylic acid ester copolymer (3-4) obtained by random copolymerization of 70 parts by mass of 2-ethylhexyl acrylate, 20 parts by mass of 2-hydroxypropyl methacrylate, and 10 parts by mass of methacrylic acid as the acrylic acid ester copolymer B.

The weight average molecular weight of the acrylic acid ester copolymer (3-4) was 370,000 and the specific dielectric constant thereof at a frequency of 100 kHz was 4.0.

### Example 1

The composition 1 for forming layer II and the composition 1 for forming layer I were coated on a release-treated polyethylene terephthalate film (DIAFOIL MRA manufactured by Mitsubishi Plastics, Inc., thickness: 100 μm) in a sheet shape using an applicator in this order, thereby fabricating a sheet-shaped laminated body of two kinds and two layers consisting of layer II/layer I (thickness of each layer: layer II/layer I=30 μm/90 μm).

In addition, the composition 1 for forming layer II was coated on a release-treated polyethylene terephthalate film (DIAFOIL MRF manufactured by Mitsubishi Plastics, Inc., thickness: 75 μm) using an applicator, thereby fabricating a sheet of the composition 1 for forming layer II having a thickness of 30 μm.

The sheet of the composition 1 for forming layer II having a thickness of 30 μm was laminated on the layer I side of the sheet-shaped laminated body of two kinds and two layers consisting of layer II/layer I, thereby fabricating a sheet-shaped laminated body of two kinds and three layers (thickness of each layer: layer II/layer I/layer II=30 μm/90 μm/30 μm).

Thereafter, the sheet-shaped laminated body was irradiated with ultraviolet light at 365 nm using a high pressure mercury lamp from the front and back sides via the polyethylene terephthalate film so as to have an integrated quantity of light of 1000 mJ/cm², thereby fabricating the double-sided pressure-sensitive-adhesive sheet 1 (thickness: 150 μm) consisting of layer II/layer I/layer II.

### Example 2

The composition 2 for forming layer I was sandwiched between two pieces of release-treated polyethylene terephthalate films (DIAFOIL MRF manufactured by Mitsubishi Plastics, Inc., thickness: 38 μm/MR, thickness: 50 μm), the resultant laminated body was treated using a laminator so as to have a thickness of 100 μm, and the laminated body was then irradiated with ultraviolet light at 365 nm using a high pressure mercury lamp from the front and back sides via the polyethylene terephthalate film so as to have an integrated quantity of light of 1000 mJ/cm², thereby fabricating 2-1 of layer I.

Separately from this, the composition 2 for forming layer II was coated on a release-treated polyethylene terephthalate film (DIAFOIL MRA 100 manufactured by Mitsubishi Plastics, Inc., thickness: 100 μm) using an applicator so as to have a thickness of 25 μm, and a release-treated polyethylene terephthalate film (DIAFOIL MRF manufactured by Mitsubishi Plastics, Inc., thickness: 75 μm) was superimposed thereon to cover. Thereafter, the resultant laminated body was irradiated with ultraviolet light at 365 nm using a high pressure mercury lamp from the front and back sides via the polyethylene terephthalate film so as to have an integrated quantity of light of 1000 mJ/cm², thereby fabricating 2-1 of layer II.

In addition, 2-2 of layer II was fabricated in the same manner as the above except that DIAFOIL MRF (manufactured by Mitsubishi Plastics, Inc., thickness: 75 and DIAFOIL MRE (manufactured by Mitsubishi Plastics, Inc., thickness: 50 μm) were used instead of the polyethylene terephthalate films used when fabricating 2-1 of layer II.

Thereafter, the 2-1 of layer II and 2-2 of layer II exposed by peeling off the polyethylene terephthalate film were respectively laminated on both surfaces of 2-1 of layer I exposed by sequentially peeling off the polyethylene terephthalate films from the front and back 2-1 of layer I, thereby fabricating the double-sided pressure-sensitive-adhesive sheet 2 (thickness of 150 μm, thickness of each layer: layer II/layer I/layer II=25 μm/100 μm/25 μm) consisting of layer II/layer I/layer II.

### Example 3

The composition 3 for forming layer II was coated on a release-treated polyethylene terephthalate film (DIAFOIL MRA 100 manufactured by Mitsubishi Plastics, Inc. thickness: 100 μm) using an applicator in sheet shape so as to have a thickness of 100 μm and a release-treated polyethylene terephthalate film (DIAFOIL MRF 75 manufactured by Mitsubishi Plastics, Inc., thickness: 75 μm) was superimposed thereon to cover, thereby fabricating the double-sided pressure-sensitive-adhesive sheet 3 (thickness of 100 μm).

### Example 4

The composition 4 for forming layer II was coated on a release-treated polyethylene terephthalate film (DIAFOIL MRA 100 manufactured by Mitsubishi Plastics, Inc., thickness: 100 μm) using an applicator in a sheet shape so as to have a thickness of 100 μm and a release-treated polyethylene terephthalate film (DIAFOIL MRF 75 manufactured by Mitsubishi Plastics, Inc., thickness: 75 was superimposed thereon to cover, thereby fabricating the double-sided pressure-sensitive-adhesive sheet 4 (thickness of 100 μm).

### Comparative Example 1

The double-sided pressure-sensitive-adhesive sheet 5 (thickness of 150 μm) consisting of layer II/layer I/layer II was fabricated in the same manner as in Example 1 except that the composition 3 for forming layer I was used instead of the composition 1 for forming layer I.

### Comparative Example 2

The composition 2 for forming layer I was coated on a release-treated polyethylene terephthalate film (DIAFOIL MRA 100 manufactured by Mitsubishi Plastics, Inc., thickness: 100 μm) using an applicator in a sheet shape so as to have a thickness of 150 μm and a release-treated polyethylene terephthalate film (DIAFOIL MRF 75 manufactured by Mitsubishi Plastics, Inc., thickness: 75 μm) was then covered thereon. The resultant laminated body was irradiated with ultraviolet light at 365 nm using a high pressure mercury lamp from the both surface sides via the release-treated polyethylene terephthalate films so as to have an integrated quantity of light of 1000 mJ/cm², thereby fabricating the double-sided pressure-sensitive-adhesive sheet 6 (thickness: 150 μm).

<Evaluation>

(Specific Dielectric Constant)

One of the release films was peeled off from the double-sided pressure-sensitive-adhesive sheets 1 to 6 fabricated in Examples and Comparative Examples, and a SUS plate (65 mm×65 mm×1 mm thick) was bonded to thereto. The left release film was then peeled off from the double-sided pressure-sensitive-adhesive sheets 1 to 6 and an aluminum foil of 45 mm φ was roll pressed thereto, thereby fabricating samples for specific dielectric constant measurement. The specific dielectric constant of the samples thus fabricated at a frequency of 100 kHz was measured at 23° C. and 50% RH using a LCR meter (HP4284A manufactured by Agilent Technologies) in accordance with JIS K6911.

It was evaluated to be “x (poor)” and “∘ (good)” when the specific dielectric constant at a frequency of 100 kHz was 3.5 or more and less than 3.5, respectively.

(Cutting Processability)

The double-sided pressure-sensitive-adhesive sheets 1 to 6 fabricated in Example and Comparative Examples were cut into 100 sheets by the Thomson blade of 50 mm×80 mm using the Thomson punching machine as the release film was laminated, and the shape of the end portion of the sheets thus cut was observed. It was evaluated to be “x (poor)” and “∘ (good)” when there was the collapse of the end portion or the floating of the release film in 10 or more sheets and less than 10 sheets, respectively.

(Adhesive Force)

One of the release films was peeled off from the double-sided pressure-sensitive-adhesive sheets 1 to 6 fabricated in Examples and Comparative Examples, and a 50 μm polyethylene terephthalate film (DIAFOIL T 100 manufactured by Mitsubishi Plastics, Inc., thickness: 50 μm) as the backing film was bonded thereto, thereby fabricating laminated articles.

The laminated articles were cut into a length of 150 mm and a width of 10 mm, and then the pressure-sensitive adhesive surface exposed by peeling off the left release film was roll pressed to a soda-lime glass. The bonded article was subjected to the autoclaving treatment (for 20 minutes at 80° C. and a gauge pressure of 0.2 MPa) to finish-adhesion, thereby fabricating a sample for adhesive force test.

The double-sided pressure-sensitive-adhesive sheet 3 fabricated in Example 3 was subjected to the autoclaving treatment, then cured by irradiating with ultraviolet light at 365 nm so as to have an integrated quantity of light of 2000 mJ/cm², and then aged hours at 23° C. and 50% RH, thereby fabricating a sample for peeling force measurement.

The peeling force (N/cm) with respect to the glass when the sample for peeling force measurement was peeled off at a peeling angle of 180° and a peeling speed of 60 mm/min was measured.

(Total Light Transmittance and Haze)

The release films of the double-sided pressure-sensitive-adhesive sheets 6 that were cut in the processability evaluation were sequentially peeled off, and a soda lime glass (82 mm×53 mm×0.5 mm thick) was roll bonded to both the front and back surfaces of the double-sided pressure-sensitive-adhesive sheets. The bonded article was subjected to the autoclaving treatment (for 20 minutes at 80° C. and a gauge pressure of 0.2 MPa) to finish-adhesion, thereby fabricating a sample for optical property measurement. For the sample thus fabricated, the total light transmittance and the haze value were measured using a haze meter (NDH5000 manufactured by NIPPON DENSHOKU INDUSTRIES Co., LTD.) in accordance with JIS K7361-1 and JIS K7136, respectively.

At this time, it was judged to be “⊙ (very good)”, “∘ (good)”, and “x (poor)” when the haze value was less than 5%, 5% or more and less than 50%, and 50% or more, respectively.

(Foaming Reliability)

The pressure-sensitive adhesive surface exposed by peeling off one of the release films from the double-sided pressure-sensitive-adhesive sheets 1 to 6 that were cut in the cutting processability evaluation was bonded to one side of a soda-lime glass (82×53 mm×0.5 mm thick) using a hand roller. Subsequently, the left release film was peeled off from the double-sided pressure-sensitive-adhesive sheets, the ZEONOR film (manufactured by ZEON CORPORATION, 100 μm thick) was roll bonded thereto, and then the resultant laminated body was subjected to the autoclaving treatment (for 20 minutes at 80° C. and a gauge pressure of 0.2 MPa) to finish-adhesion, thereby fabricating a laminated body for reliability evaluation.

For the sheet 3 fabricated in Example 3 was subjected to the autoclaving treatment and then cured by irradiating with ultraviolet light at 365 nm from the surface of soda-lime glass so as to have an integrated quantity of light of 2000 mJ/cm², thereby fabricating the same sample.

The laminated bodies for reliability evaluation thus fabricated were aged for 6 hours at 85° C., and it was judged to be “x (poor)” and “∘ (good)” for the pressure-sensitive-adhesive sheets which were foamed or floated and the pressure-sensitive-adhesive sheets which were not foamed or floated, respectively.

TABLE 1

| | | | | | | | Comparative | Comparative |
|---|---|---|---|---|---|---|---|---|
| | | | Example 1 | Example 2 | Example 3 | Example 4 | Example 1 | Example 2 |
| Configuration of layer | | | II/I/II | II/I/II | Layer II | Layer II | II/I/II | Layer I |
| Layer I | Acrylic | A-1 | 50 | | — | — | | |
| | compound (A) | A-2 | | 100 | | | | 100 |
| | Acrylic acid | B-1 | 50 | | | | 100 | |
| | ester | | | | | | | |
| | copolymer (B) | | | | | | | |
| | (Meth)acrylic | D-1 | | | | | 20 | |
| | acid ester | | | | | | | |
| | monomer (D) | | | | | | | |
| | Photopolymerization | C-1 | 1 | | | | | |
| | initiator (C) | C-2 | | 2 | | | | 2 |
| | | C-3 | | | | | 1.5 | |
| Layer | Acrylic | A-1 | | | 20 | | | — |
| II | compound (A) | A-3 | | | | 60 | | |
| | Acrylic acid | B-1 | 100 | | | | 100 | |
| | ester | B-2 | | 100 | | | | |
| | copolymer (B) | B-3 | | | 100 | | | |
| | | B-4 | | | | 100 | | |
| | Photopolymerization | C-1 | 1.5 | 1.5 | 2 | 1.5 | 1.5 | |
| | initiator (C) | | | | | | | |

TABLE 2

| | | | | | | Comparative | Comparative |
|---|---|---|---|---|---|---|---|
| | | Example 1 | Example 2 | Example 3 | Example 4 | Example 1 | Example 2 |
| Specific | — | 3.0 | 2.6 | — | — | 3.7 | 2.6 |
| dielectric | | | | | | | |
| constant | | | | | | | |
| (layer I) | | | | | | | |
| Specific | — | 3.8 | 4.6 | 3.4 | 3.3 | 3.8 | — |
| dielectric | | | | | | | |
| constant | | | | | | | |
| (layer II) | | | | | | | |
| Specific | — | ◯ | ◯ | ◯ | ◯ | X | ◯ |
| dielectric | | 3.3 | 3.0 | 3.4 | 3.3 | 3.8 | 2.6 |
| constant | | | | | | | |
| (entire) | | | | | | | |
| (f = 100 kHz) | | | | | | | |
| Cutting | — | ◯ | ◯ | ◯ | ◯ | ◯ | X |
| processability | | | | | | | |
| Total light | % | 91 | 91 | 91 | 85 | 91 | 91 |
| transmittance | | | | | | | |
| Haze | % | ⊙ | ⊙ | ⊙ | ◯ | ⊙ | ⊙ |
| Adhesive force | N/cm | 10 | 7 | 20 | 5 | 10 | <0.1 |
| Foaming | — | ◯ | ◯ | ◯ | ◯ | ◯ | X |
| reliability | | | | | | | |
| Overall | — | ◯ | ◯ | ◯ | ◯ | X | X |
| evaluation | | | | | | | |

The sheets 1 to 4 fabricated in Examples 1 to 4 were achieved both excellent pressure-sensitive adhesive properties and excellent optical properties while securing a low specific dielectric constant value.

In contrast, the sheet fabricated in Comparative Example 1 did not contain the acrylic compound (A) having a specific dielectric constant at 100 kHz of 3.0 or less, and thus the specific dielectric constant value thereof was high and the sheet could not satisfy the electric properties. The sheet of Comparative Example 2 was fabricated using only the acrylic compound (A) having a specific dielectric constant of 3.0 or less, and thus it was poor in tackiness or adhesive force as a pressure-sensitive-adhesive sheet, and processability or reliability after bonding of members was not obtained.

1. A double-sided pressure-sensitive-adhesive sheet comprising:
an acrylic compound (A) having a specific dielectric constant at a frequency of 100 kHz of 3.0 or less; and
an acrylic acid ester copolymer (B) obtained by copolymerizing a (meth)acrylic acid ester monomer having a straight-chain or branched alkyl group having from 1 to 9 carbon atoms in a side chain and/or a vinyl ether monomer.

2. The double-sided pressure-sensitive-adhesive sheet according to claim 1, wherein the acrylic compound (A) is a polyfunctional (meth)acrylate having a polyolefin backbone and a weight average molecular weight of from 500 to 100,000.

3. The double-sided pressure-sensitive-adhesive sheet according to claim 1, wherein the acrylic compound (A) is a urethane (meth)acrylate obtained by reacting a polyolefin (a-1) having a hydroxyl group at a terminal or in a side chain, an aliphatic polyisocyanate (a-2), and a hydroxyl group-containing (meth)acrylate (a-3).

4. The double-sided pressure-sensitive-adhesive sheet according to claim 1, wherein a weight average molecular weight of the acrylic acid ester copolymer (B) is from 100,000 to 700,000.

5. The double-sided pressure-sensitive-adhesive sheet according to claim 1, further comprising a photopolymerization initiator (C).

6. The double-sided pressure-sensitive-adhesive sheet according to claim 1, further comprising a (meth)acrylic acid ester monomer (D).

7. The double-sided pressure-sensitive-adhesive sheet according to claim 1, wherein the acrylic compound (A) is present at from 10 to 95% by mass based on the entire sheet.

8. The double-sided pressure-sensitive-adhesive sheet according to claim 1, comprising a first layer comprising the acrylic compound (A) and a second layer comprising the acrylic acid ester copolymer (B).

9. The double-sided pressure-sensitive-adhesive sheet according to claim 8, wherein the second layer comprises the acrylic compound (A) and the acrylic acid ester copolymer (B).

10. The double-sided pressure-sensitive-adhesive sheet according to claim 8, wherein the first layer comprises the acrylic compound (A) in an amount of from 10 to 99% by mass.

11. The double-sided pressure-sensitive-adhesive sheet according to claim 8, wherein the second layer comprises the acrylic acid ester copolymer (B) in an amount of from 10 to 99% by mass.

12. The double-sided pressure-sensitive-adhesive sheet according to claim 1, comprising a layer comprising the acrylic compound (A) and the acrylic acid ester copolymer (B).

13. The double-sided pressure-sensitive-adhesive sheet according to claim 1, wherein a 180° peel force when one surface of the double-sided pressure-sensitive-adhesive sheet is superimposed and press-bonded on a soda-lime glass and the double-sided sided pressure-sensitive-adhesive sheet is peeled off from the soda-lime glass at 23° C. and a peeling speed of 60 mm/min is 5.0 N/cm or more.

14. The double-sided pressure-sensitive-adhesive sheet according to claim 1, wherein a total light transmittance measured for the double-sided pressure-sensitive-adhesive sheet having both surfaces sandwiched between soda-lime glasses with a thickness of 0.5 min in accordance with JIS K7361-1 is 85% or more and a haze for the double-sided pressure-sensitive-adhesive sheet having both surfaces sandwiched between soda-lime glasses with a thickness of 0.5 mm in accordance with JIS K7136 is 5% or less.

15. A double-sided pressure-sensitive-adhesive sheet laminated body formed by laminating the double-sided pressure-sensitive-adhesive sheet according to claim 1 and a release film.

16. A laminated body formed by laminating image display device constituting members via the double-sided pressure-sensitive-adhesive sheet according to claim 1.

17. A laminated body formed by irradiating a double-sided pressure-sensitive-adhesive sheet of a laminated body formed by laminating image display device constituting members via the double-sided pressure-sensitive-adhesive sheet according to claim 1 with ultraviolet light via the image display device constituting member to ultraviolet crosslink the double-sided pressure-sensitive-adhesive sheet.

18. The laminated body according to claim 16, wherein the image display device constituting member is any one selected from the group consisting of a touch panel, an image display panel, a surface protective panel, a retardation film, and a polarizing film, or a laminated body comprising a combination of two or more kinds thereof.

19. An image display device comprising the laminated body according to claim 16.
